(19) United States
(12) Patent Application Publication
(10) Pub. No.: US 2024/0422141 A1
(43) Pub. Date: Dec. 19, 2024

(54) CONFIRMING EMAIL MESSAGE INTEGRITY

(71) Applicant: International Business Machines Corporation, Armonk, NY (US)

(72) Inventors: Benjamin William Shade, Waterlooville (GB); Krithika Ramachandran, Georgetown, TX (US); Mauro Marzorati, Lutz, FL (US); Michael Guilford, Cary, NC (US)

(21) Appl. No.: 18/337,082

(22) Filed: Jun. 19, 2023

(51) Int. Cl. H04L 9/40; H04L 51/48

(52) U.S. Cl. CPC H04L 63/0442; H04L 51/48

(57) ABSTRACT

Original content of an email message is verified upon receipt of the email message at a receiver mail server prior to presenting the email message to a recipient. Determination of original content is made by comparing a verification hash value to a calculated hash value of the received email message. When the verification hash value does not match the calculated hash value, an invalidity warning is presented to the recipient with an option to view the invalid email message.

### BACKGROUND

The present invention relates generally to the field of email technology, and more particularly to email security and verification of original email message content.

The Mail From address is the email address to which bounce messages are delivered. The Mail From address is included in the SMTP (simple mail transfer protocol) envelope (data part of the SMTP protocol). The Display From address is the email address that is displayed to the end user within their email client or the mail user agent (MUA). The Display From address is contained in the header (metadata) of the email message; often displayed in the From field. The MUA does not have access to the SMTP (simple mail transfer protocol) envelope and therefore cannot determine the aforementioned Mail From address. The Display From address can be different than the Mail From address.

Conventional email integrity schemes exist. For example, sender policy framework (SPF) enables the sender domain to publicly state which MTA servers (IPs) may send emails on its behalf, working in the envelope of the message. Domain-based message authentication, reporting, and conformance (DMARC) allows the receiver to check that an email claimed to have come from a specific domain was indeed authorized by the owner of that domain and gives email domain owners the ability to protect their domain from unauthorized use, by extending SPF and DKIM mechanisms. Secure/multipurpose internet mail extension (S/MIME) provides the following cryptographic security services for electronic messaging applications.

### SUMMARY

In one aspect of the present invention, a method includes: determining an original message is sent from an email account; retrieving a hashing algorithm for calculating a verification hash value of content of the original message; calculating a validation hash value of the content of the original message using the hashing algorithm; storing the validation hash value and a message identifier for the original email message; and sending a verifiable message to a target mail server.

In another aspect of the present invention, a method includes: receiving an email message and a message identifier from a sender email server, the email message sent to a target recipient of a target mail server; retrieving, by the target mail server, a hashing algorithm for calculating an independent hash value of content of the email message; calculating, by the target mail server, the independent hash value of the content of the email message using the hashing algorithm; requesting a validation hash value from a mail verification agent associated with a domain name system of the received email message; comparing the independent hash value to the validation hash value; and responsive to a result of the comparing being positive or negative, sending, by the target mail server, a responsive communication to the target recipient.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a first method performed, at least in part, by the first embodiment system;

FIG. 3 is a flowchart showing a second method performed, at least in part, by the first embodiment system;

FIG. 4 is a schematic view of a machine logic (for example, software) portion of the first embodiment system;

FIG. 5 is a schematic diagram view of a second embodiment of a system according to the present invention;

FIG. 6A is a flowchart view of a first method performed, at least in part, by the second embodiment system; and

FIG. 6B is a flowchart view of a second method performed, at least in part, by the second embodiment system.

### DETAILED DESCRIPTION

Original content of an email message is verified upon receipt of the email message at a receiver mail server prior to presenting the email message to a recipient. Determination of original content is made by comparing a verification hash value to a calculated hash value of the received email message. When the verification hash value does not match the calculated hash value, an invalidity warning is presented to the recipient with an option to view the invalid email message. The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of one or more transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as content integrity program 450. In addition to block 450, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 450, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

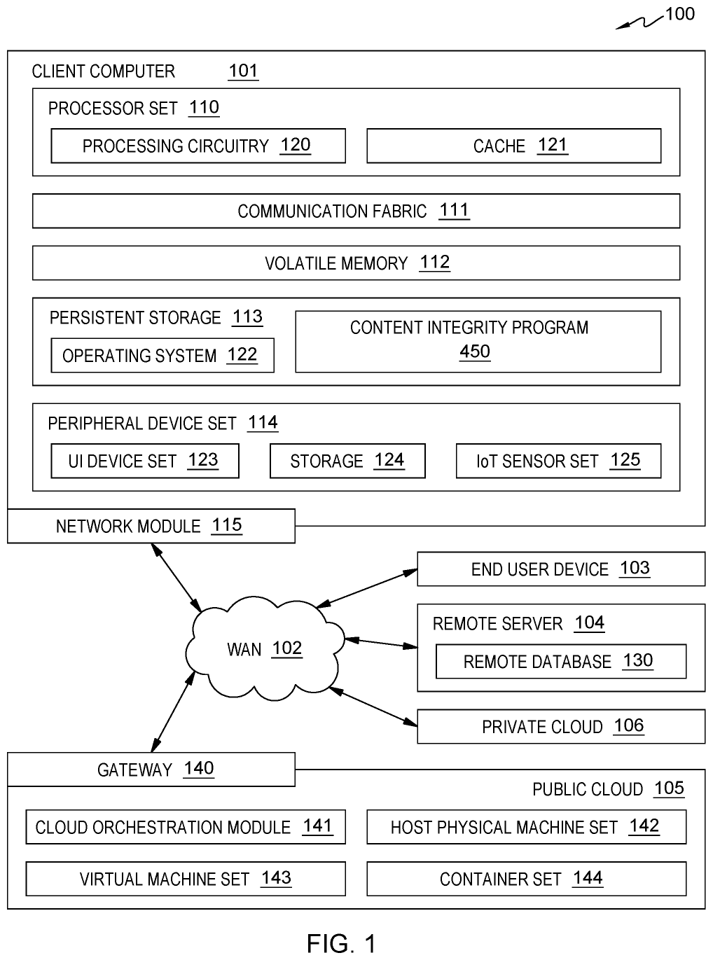

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 450 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 450 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Content integrity program 450 operates to provide authoritative confirmation of the originality of an email message when transmitted from one user to another via email servers. Some embodiments of the present invention operate regardless of the sender and receiver operating within the same domain name system (DNS). The program further operates to manage tuples containing message identification numbers and original hash values for content verification by a receiving mail user agent (MUA). Verification includes independent calculation of a hash value for the received email content by the receiving MUA. Hash algorithms are managed in the DNS and are provided to the verification agent associated with a given DNS.

Some embodiments of the present invention recognize the following facts, potential problems and/or potential areas for improvement with respect to the current state of the art: (i) email authenticity or security schemes often operate only at the envelope level; (ii) email authenticity or security schemes that operate at the email message level rely on Public Key Infrastructure (PKI) where each email message in a corresponding relationship must be enabled for secure or authenticated transmission; (iii) despite efforts to ameliorate the discovery of encryption keys, each correspondent must operate and manage their private encryption key for these authenticity schemes to work; (iv) the protocols SPF and DMARC, which are outside the envelope mechanisms, cannot vouch for the integrity of the received message contents; (v) S/MIME suffer from certain drawbacks including: a) not well suited for use via webmail clients; b) designed for end-to-end encryption, which prevents inspection for malware en route; and c) requires PKI facilities is significant barrier of entry to S/MIME adoption; (vi) DMARC provides the ability for an organization to publish a policy that specifies which mechanism among DKIM, SPF, or both is employed when sending email from that domain; (vii) DMARC provides the ability for an organization to how to check the from field presented to end users; (viii) DMARC provides the ability for an organization to how the receiver should deal with failures; and/or (ix) DMARC provides the ability for an organization to use a reporting mechanism for actions performed under those policies.

Some embodiments of the present invention are directed to a method of publishing assertions regarding originality or authenticity of message contents in a manner that can be easily queried by any email message receiver.

Some embodiments of the present invention incorporate a new email system component known as the “Mail Verification Agent” or MVA. The MVA component provides message content verification hashes to MUAs.

Some embodiments of the present invention avoid the complexities of assuring email message integrity using digital certificates, enrollment, distribution, and trust by providing an out-of-band method to verify hashes of email message content. In that way, the recipient submits a query with the message ID provided by the sending email server to a repository of saved message content hashes to verify integrity of the email message. Because hashes are one-way calculations, the message content hashes can be shared without exposing the actual contents of the messages.

Some embodiments of the present invention use DNS text records to direct users to the authorized server. In this case, the text record has been specially created for this purpose. For example, the file Checksum.txt may list the values such as IP addresses of the authorized servers. The client is able to use the listed servers to query for the message content hash, which completes the fully out-of-band method of integrity check on the received email message.

Some embodiments of the present invention are directed to an additional domain name system (DNS) resource record referred to herein as the mail verification agent (MVA) resource record, which works similarly to DKIM (domainkeys identified mail) and DMARC (domain-based message authentication, reporting, and conformance) protocols.

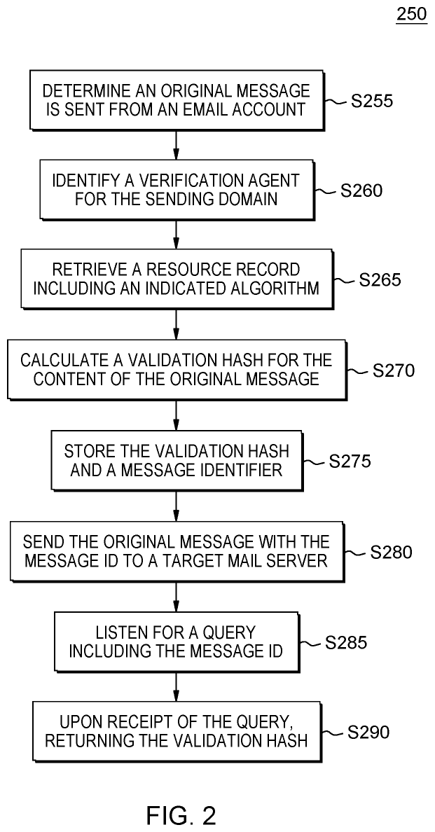

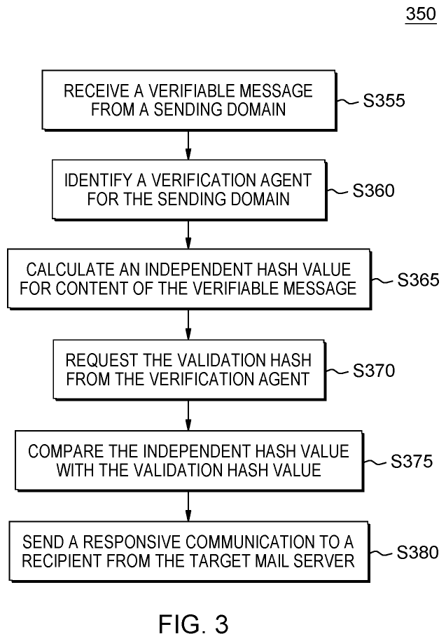

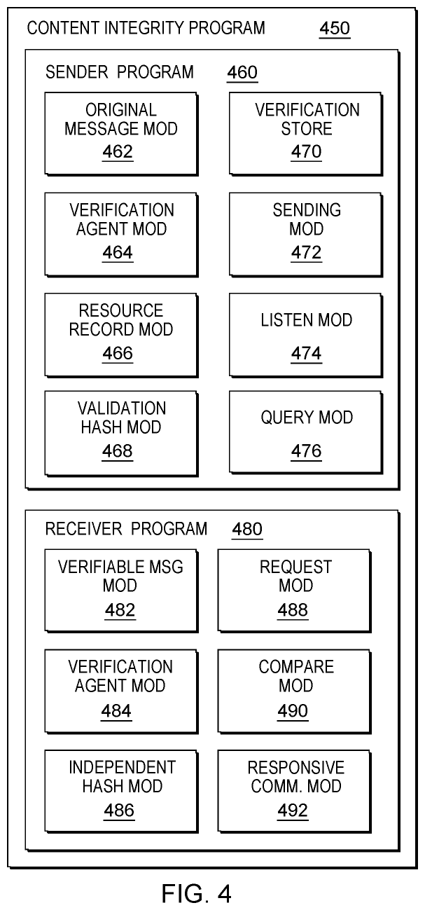

FIG. 2 shows flowchart 250 depicting a first method for sending verifiable original email messages according to the present invention. FIG. 3 shows flowchart 350 depicting a second method for receiving a verifiable email message and confirming original email content in the received email message. FIG. 4 shows program 450 for performing at least some of the method steps of flowchart 250, by sender program 460, and flowchart 350, by receiver program 480. The first method and associated software will now be discussed, over the course of the following paragraphs, with extensive reference to FIG. 2 (for the method step blocks) and FIG. 4 (for the software blocks).

Processing begins at step S255, where original message module (“mod”) 462 of sender program 450 determines an original message is sent from an email account. In this example, the original message mod monitors outgoing messages from the email account. Alternatively, upon initiating a send action by a user, the original message mod determines that an original message is being sent.

Processing proceeds to step S260, where verification agent mod 464 identifies a mail verification agent (MVA) for the sending domain. Upon determining that an original message is being sent, the verification agent mod determines the domain name system (DNS) of the email account and the corresponding MVA server for use in confirming the integrity of the original message. For each DNS there is an assigned MVA server to facilitate verification of the content of original messages originating from the DNS.

Processing proceeds to step S265, where resource record mod 466 retrieves a resource record including an indicated algorithm. Upon identifying the appropriate MVA server, the resource record module operates to retrieve the resource record from the MVA. The resource record includes a designated hashing algorithm for the identified MVA server. In some embodiments of the present invention, a predefined set of hashing algorithms are assigned to a DNS such that the retrieved resource record includes one of the predefined hashing algorithms. The predefined set of hashing algorithms may, for example, be stored in remote database 130 (FIG. 1). In some embodiments of the present invention, assignment of a sub-set of hashing algorithms to a particular DNS is performed when setting up the MVA server for the particular DNS.

Processing proceeds to step S270, where validation hash mod 468 calculates a validation hash value for the content of the original message. In this example, the identified original message includes message content for which a validation hash value is calculated. The message content includes the substantive portion of the original message such as the text of the body of the original message, also referred to as the body text or body copy. Alternatively, the content of the original message includes message content as well as sender, recipients, subject line, and/or message attachments for which the validation hash value is calculated. Regardless of what the makes up the content, the validation hash module calculates a validation hash value for the content.

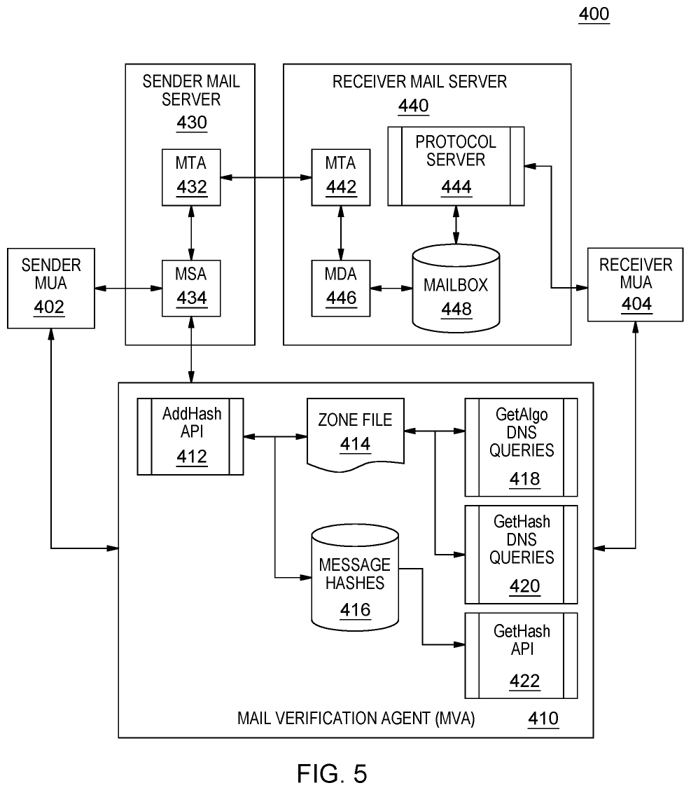

Processing proceeds to step S275, where verification store mod 470 stores the validation hash and a message identifier. In this example, a message identifier is established for identifying the original message. The message identifier and the validation hash value calculated in step S270 are combined to form a verification tuple, which is stored for later reference. In the discussion that follows, specific components handle various aspects of the process. For example, the mail submission agent (MSA) of the sender mail server calculates the validation hash value of the content and establishes the message identifier for the original message. The MSA also establishes the message identifier and creates a tuple containing the validation hash value and the message identifier. The tuple is submitted to the designated mail verification agent (MVA) server for storage. In this example, the verification store module stores the validation hash value. The storing may occur in message hash store such as message hashes store 416 (FIG. 5) or in remote database 130 (FIG. 1).

Processing proceeds to step S280, where sending mod 472 sends the original message with the message identifier to a target mail server. In this example, the sending module operates responsive to the storing of the verification tuple. Alternatively, the sending module operates responsive to submission of the verification tuple to the MVA server for storage. Alternatively, the sending module send the original message with the message identifier when the message identifier is established regardless of the storing of creation of the verification tuple. The target mail server is identifiable as the mail server of a target recipient. When a message dataset including the original message and message identifier are received by the target mail server, the message dataset is recognizable by the target mail server as a verifiable message. As discussed in process 350, below, the target mail server may operate to verify the contents of the verifiable message (FIG. 3).

Processing proceeds to step S285, where listen mod 474 listens for a query including the message identifier. In this example, the designated mail verification agent (MVA) listens for a query including the message identifier. When a verification tuple received by the MVA server, whether received as a submission for storage or directly stored to a corresponding message hash store, a listening service is established. In some embodiments of the present invention, the listening service is initialized for well-known ports for DNS and/or HTTPS to accept queries indicating only the message ID provided with the verification tuple.

Processing ends at step S290, where query mod 476, upon receipt of the query, returns the validation hash value. During listening, when the listen module receives a query indicating a valid message ID, the corresponding verification hash value is retrieved from the stored tuple. The query module responds with the verification hash value. As described herein, verification of the content of an original message is performed by storing a verification hash value of the content for return upon receipt of a query of a corresponding message identifier. The returned verification hash value serves as a reference hash in a process described below with respect to the receiving email server.

The second method and associated software will now be discussed, over the course of the following paragraphs, with extensive reference to FIG. 3 (for the method step blocks) and FIG. 4 (for the software blocks).

Processing begins at step S355, where verifiable message module (“mod”) 482 receives a verifiable message from a sending domain. In this example, the verifiable message is identified by the verifiable message module when a message dataset including a message identifier is received from the sender. According to some embodiments of the present invention, the message identifier is added to the message dataset by the sender mail submission agent.

Processing proceeds to step S360, where verification agent mod 484 identifies a mail verification agent (MVA) server for the sending domain. In a similar manner as described in step S260 of process 250 (FIG. 2), the verification agent module determines the domain name system (DNS) of the received email message and the corresponding MVA server for use in confirming the integrity of the received message.

Processing proceeds to step S365, where independent hash mod 486 calculates an independent hash value for content of the verifiable message. The independent hash module retrieves the designated hashing algorithm from the identified MVA server. By independent calculation, the hash module uses the designated hashing algorithm and content of the received verifiable message to create an independent hash value.

Processing proceeds to step S370, where request mod 488 requests the validation hash value from the identified MVA server. In addition to calculating the independent hash value for the received verifiable message, the validation hash value is requested from the identified MVA server. In this example, the request for the validation hash consists only of the message identifier received in the message dataset, which was received at step S355. Alternatively, the message identifier is linked to the verifiable message for retrieval.

Processing proceeds to step S375, where compare mod 490 compares the independent hash value with the validation hash value. Having the validation hash value representing the content of the original message and the independently calculated hash value for representing the content of the received message, an analysis may be performed to confirm the integrity of the received message. The integrity being that the content of the received message matches the content of the original message that was sent from the sender mail server.

Processing ends at step S380, where responsive communication mod 492 sends a responsive communication to a recipient from the target mail server. In this example, the result of the comparison in step S375 is the basis for a determination of the integrity or authenticity of the received email message. Alternatively, other factors are also considered including reliability of the DNS from which the email was sent, reliability of the sender, duration of time between sending and receiving of the email message, and/or level of importance assigned to the email message.

In this example, when the independent hash value matches the validation hash value, the received message is deemed to be unaltered from the original message sent by the sending mail server. Accordingly, the received email is presented to the target recipient as a validated message. When the independent hash value does not match the validation hash value, the received message is deemed to be altered with respect to the original message. Accordingly, a warning message is presented to the target recipient for further review. Some embodiments of the present invention provide for the target recipient to select an option to view the received email despite the warning of invalidity.

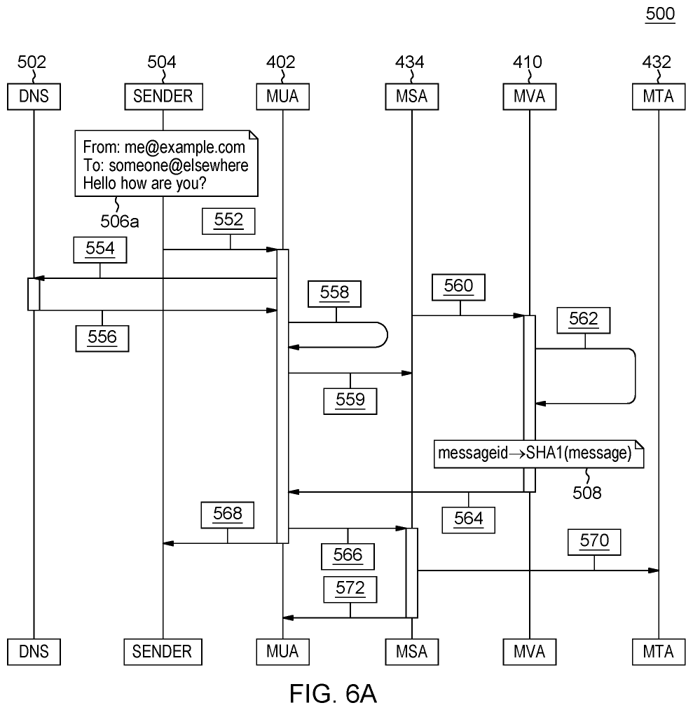

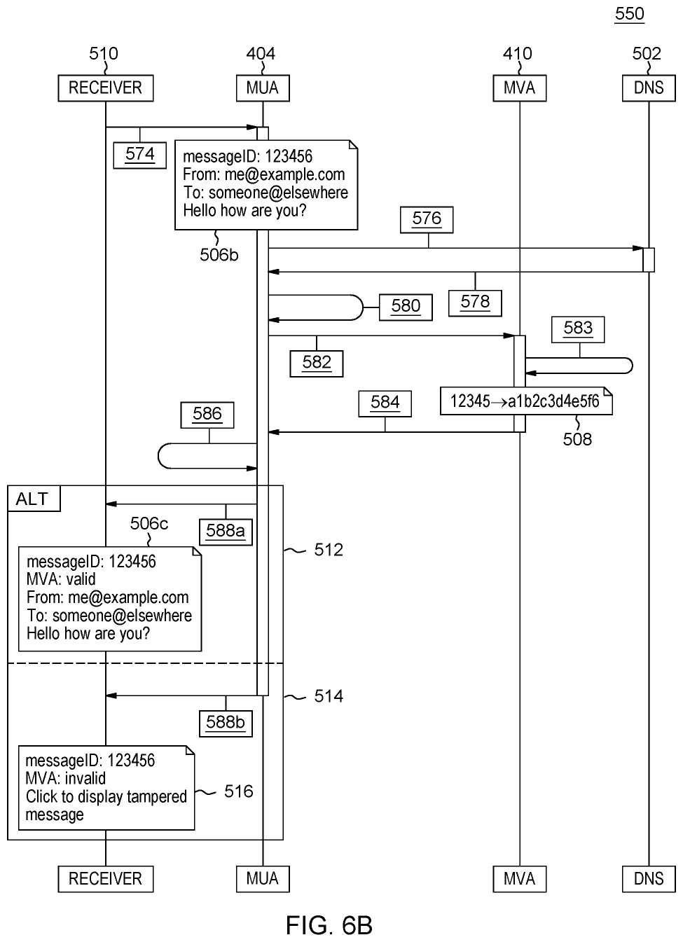

Further embodiments of the present invention are discussed in the paragraphs that follow and later with reference to FIGS. 5-6B.

Some embodiments of the present invention provide authoritative confirmation of the originality of email message content indicating whether there has been tampering with the message content at the receiving end.

FIG. 5 shows a system diagram for mail verification agent (MVA) system 450 including various components of the MVA resource record and how the MVA resource record may interact with an example sender mail server and an example receiver mail server of a typical DNS. MVA system 450 includes the following: sender mail user agent (MUA) 402, receiver mail user agent (MUA) 404, sender mail verification agent (MVA) server 410, AddHash API 412, zone file 414, message hashes store 416, GetAlgo DNS queries 418, GetHash DNS queries 420, GetHash API 422, sender mail server 430, sender mail transfer agent (MTA) 432, sender mail submission agent (MSA) 434, receiver mail server 440, receiver mail transfer agent (MTA) 442, receiver protocol server 444, mail delivery agent (MDA) 446, and receiver mailbox 448.

The MVA system illustrated in FIG. 5 is one configuration where the sending MVA server may provide message verification hashes to receiving mail user agents for matching hash values. An example operation of MVA system 450 includes identifying sender MVA server 410 as the designated verification server of the email sending domain of sender mail server 430, upon sending an email message from sender MUA 402, calculating a hash value for the email message content by sender MSA 434, and providing the hash value to the designated MVA server, sender MVA server 410, for storage in message hashes store 416. The email message transmitted and received according to a conventional manner via receiver mail server 440 to receiver MUA 404.

Further to the example, a recipient may desire verification of the content in the email message. Verification may be automated upon receipt of a request to display the email message or may be selectively requested by the recipient. The verification process may be performed as follows. Upon request to display the received email message, receiver MUA 404 calculates the hash of the received email message, queries the designated verification server, sender MVA server 410 for the hash value provided by the sender MSA 434, and compares the two hash values to verify email message content as being the same as originally sent by sender MUA 402.

Some embodiments of the present invention are directed to validation of email message contents, inside the envelope, independent of cryptographic signatures or other pre-shared secrets mechanisms.

Some embodiments of the present invention are directed to validation of email message content, inside the envelope, without any action from the end user.

Some embodiments of the present invention are directed to publication of a selected in-use hashing algorithm based on a given domain. The hashing algorithm may be selected from a set of appropriate algorithms for hashing email messages. The email message integrity verifications described herein facilitate transparent interoperability with existing email protocols, such as SMTP, POP3 (post office protocol 3), and IMAP (internet messaging access protocol), and conventional server and client components of domain name systems.

According to some embodiments of the present invention, the MVA resource record follows similar protocol constructs as the SPF (send policy framework), DMARC (domain-based message authentication, reporting, and conformance), and DKIM (domainkeys identified mail) protocols by using a specially crafted TXT resource record type. The format of the MVA resource record may be, for example:
(i) v=mva1; algo=SHA1; method=DNS; server=mva.example.com; or
   (ii) v=mva1; method=https; algo=SHA2; server=mva.emaple.com.It should be noted that the MVA resource record format indicates the hash algorithm in use, the TCP (transmission control protocol) port, and the protocol to use for message hash consultations. (Note: the term “DOMAINKEYS” may be subject to trademark rights in various jurisdictions throughout the world and are used here only in reference to the products or services properly denominated by the marks to the extent that such trademark rights may exist.)

Some embodiments of the present invention are directed to validating, for a receiver of any email message, that the received email message has not been tampered with or changed in any way. The validation is performed independent of any cryptographic signatures through a consultation to an authoritative source such as an MVA server associated with the domain of the sender MUA originating the email message.

Referring again to FIG. 5, MVA system 450 incorporates MVA server 410 into a DNS system for transmitting email messages with verifiable content from sender MUA 402 to receiver MUA 404. FIGS. 6A and 6B illustrate content verification processes 500 and 550, which may be performed by content integrity program 450 and the corresponding computing environment 100 (FIG. 1). Verification process 500 illustrates operations of MVA server 410 when sender 504 sends email message 506a from the domain of example.com, domain name system (DNS) 502. Verification process 550 illustrates operations of the MVA server when receiver 510 receives email message 506b from the sender using example.com in DNS 502. It should be noted that email messages 506a and 506b are not necessarily different in message content, but they are different in that email message 506b includes message identifier (ID) 123456, which is added to the email message dataset upon creation of a message ID. The message ID is used at least to track message hashes when stored by the MVA server, for example, in message hashes store 416.

According to an exemplary process as illustrated in FIG. 6A, sender 504 generates email message 506a according to conventional processes and directs sender mail user agent (MUA) 402 to send the email message (552). In order to apply the correct hash algorithm, the sender MUA looks up the MVA resource record (554) in DNS 502 for the sending domain, example.com. Upon receipt of the hash algorithm from the MVA resource record (556), the sender (MUA) calculates a hash using an indicated hash algorithm for creating a hash value for the contents of the email message (558) and associates the hash value with the message identifier (ID) for the email message. The sender MUA transmits the email message, the message ID, and the calculated hash value to sender mail submission agent (MSA) 434 (559).

Upon receipt of the email message, the message ID, and the calculated hash value from the sender MUA, the sender MSA transmits the hash value and the message ID to MVA server 410 (560). The MVA server stores the message ID and corresponding hash value as tuple 508 locally in message hashes store 416 (562). The MVA server reports completion of step 562 to the sender MUA (564). Sender MUA 402 submits the email message to the sender MSA for processing (566). The sender MUA reports to sender 504 that the email message was sent to receiver 510 (568). The sender MSA places the email message in an outbound queue of sender mail transfer agent (MTA) 432 for delivery to the receiver 510 (570). The sender MSA report completion of step 570 to the sender MUA (572). According to some embodiments of the present invention, the message ID/hash value tuple is made available to the designated MVA server after the email message is transmitted to the sender MTA. In this example, the MVA server is remote to sender mail server 430. Alternatively, the MVA server is onboard the sender mail server. According to some embodiments of the present invention, the MVA server stands up a listening service in well-known ports for one or both DNS and HTTPS protocols and accepts queries indicating only “<messageid>” indicating the stored message IDs such as the one stored at step 562. No further information is needed to be submitted to the MVA server. Upon receipt of the message ID query, the MVA server looks up the specified “<messageid>” in local storage, such as message hashes store 416, and provides the hash value as originally submitted by the sender MSA at step 560.

According to another exemplary process as illustrated in FIG. 6B, receiver 510 requests retrieval of email message 506b from receiver mail user agent (MUA) 404 (574). The receiver MUA performs a DNS lookup in domain name system (DNS) 502 for the sending mail verification agent (MVA) resource record (576). The receiver MUA further obtains the MVA server address and communication scheme for the specified email message. In that way, the receiver MUA can extract the hash algorithm stored in message hashes store 416 of the corresponding mail verification agent (MVA) server, MVA server 410 (578). The receiver MUA performs an independent hash calculation of the received message content based on the extracted hash algorithm (580). The receiver MUA further contacts the MVA server in the indicated port, submitting only the <messageid> to the MVA server (582), which is 123456, as shown in email message 506b.

In this example, the outgoing request from the receiver MUA to the MVA server is written in the following format:
dig TXT <messageid>._mva.example.com
   with the MVA server retrieving from storage the hash corresponding to the provided message identifier (ID) (583) and returning “hash=a1b2c3d4c5f6” 508 to the receiver MUA (584). Alternatively, the hash request is written in the following format:
cURL https://mva.example.com/?messageid=<messageid>
   with the MVA server returning the hash=a1b2c3d4e5f6.

The receiver MUA, having received the stored hash 508 for email message 506a and having calculated the hash for email message 506b, has the information needed to verify contents of the received email message match that of the sent email message. Accordingly, the receiver MUA proceeds to compare the stored hash to the calculated hash (586). The outcome of the comparison determines what message is communicated to receiver 510. When the two hashes match (512), validated email message 506c is communicated to the receiver (588a). In this example, the validated email message includes an assertion from the mail validation agent that the message is “valid.” Alternatively, receipt of the message allows the receiver to infer validation of the message. When the two hashes do not match (514), invalid message 516 is communicated to the receiver (588b). In this example, the invalid message communication provides a link for the user to access the invalid message despite the determination of invalidity by the MVA.

Some embodiments of the present invention may include one, or more, of the following features, characteristics and/or advantages: (i) provides inherent validation of message integrity without the involvement of the sender or receiver; (ii) zero barrier of entry to the end user; (iii) interoperable deployment at each sending domain; (iv) the mail verification agent (MVA) may be used by conventional MUA and MSA program developers; (v) validates the authenticity of an email message provenance; (vi) provides integrity verification out of band, without the use of digital signatures or cryptographic verification; (vii) introduces a mail verification agent (MVA) for verification methods disclosed herein; (viii) a text record lists which MVA servers are authorized to identify the specific email messages sent from certain DNS servers; and/or (ix) the receiver client validates the received email; and/or (x) authenticity is provided by computing a message hash and comparing the source and destination hash in an out of band method using an MVA.

Some embodiments of the present invention are directed to a process for a receiver of any email message to validate that the received email has not been tampered with independent of cryptographic signatures through a consultation to an authoritative source. The process may include the following process elements. Sender of email writes email message and hits send. In order to apply the correct hash algorithm, the mail user agent looks up the mail verification agent resource record in DNS for the sending domain. The mail user agent calculates a hash using the indicated algorithm for the contents of the message and transmits it to the mail submission agent. The mail submission agent upon receipt of the mail message from the mail user agent records the received message content hash and the received mail message identifier as a tuple locally. The message is then placed in the outbound queue of the mail transfer agent for delivery to recipient. The tuple is made available to the mail verification agent, which may be onboard or remote. The mail verification agent will execute a listening service in well-known ports for DNS, HTTPS, or both, and accept queries indicating only the mail message identifier. Upon receipt of a query the mail verification agent looks up the mail message identifier in local storage and provides the hash value originally submitted by the mail submission agent. The mail user agent of the mail recipient performs a DNS lookup for the mail verification agent resource record and extracts the hash algorithm and the mail verification agent server address and communication scheme. The mail user agent performs an independent hash calculation of the message content and contacts the mail verification agent service in the indicated port, submitting only the mail message identifier to the mail verification agent,

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above-similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method for creating a verifiable email message, the method comprising:
determining an original message is sent from an email account;
retrieving a hashing algorithm for calculating a verification hash value of content of the original message;
calculating a validation hash value of the content of the original message using the hashing algorithm;
storing the validation hash value and a message identifier for the original email message; and
sending a verifiable message to a target mail server.

2. The computer-implemented method of claim 1, further comprising:
identifying a mail verification agent for a sending domain name system of the email account;
wherein:
retrieving the hashing algorithm includes obtaining a resource record for the mail verification agent, the resource record indicating the hashing algorithm.

3. The computer-implemented method of claim 2, wherein storing the validation hash value includes:
submitting the validation hash value to the mail verification agent; and
storing a validation tuple to a message hash store, the validation tuple being an order pair including the validation hash value and the message identifier.

4. The computer-implemented method of claim 1, further comprising:
initializing a listening service for a query including the message identifier, the listening performed for domain name system ports.

5. The computer-implemented method of claim 1, further comprising:
responsive to a query from a domain name system port for a message identifier, returning the validation hash value.

6. The computer-implemented method of claim 1, wherein the content of the original message includes only message content.

7. The computer-implemented method of claim 1, wherein the verifiable message is a message dataset including the original message and the message identifier.

8. A computer-implemented method for verifying content of an email message, the method comprising:
receiving an email message and a message identifier from a sender email server, the email message sent to a target recipient of a target mail server;
retrieving, by the target mail server, a hashing algorithm for calculating an independent hash value of content of the email message;
calculating, by the target mail server, the independent hash value of the content of the email message using the hashing algorithm;
requesting a validation hash value from a mail verification agent associated with a domain name system of the received email message;
comparing the independent hash value to the validation hash value; and
responsive to a result of the comparing being positive or negative, sending, by the target mail server, a responsive communication to the target recipient.

9. The computer-implemented method of claim 8, further comprising:
identifying the mail verification agent for a sending domain name system of the email message;
wherein:
retrieving the hashing algorithm includes obtaining a resource record for the mail verification agent, the resource record indicating the hashing algorithm.

10. The computer-implemented method of claim 8, wherein requesting the validation hash is performed by submitting a query containing only the message identifier to the mail verification agent.

11. The computer-implemented method of claim 8, wherein the content of the email message includes only message content.

12. A computer system for verifying content of an email message, the computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to perform a method comprising:
receiving an email message and a message identifier from a sender email server, the email message sent to a target recipient of a target mail server;
retrieving, by the target mail server, a hashing algorithm for calculating an independent hash value of content of the email message,
calculating, by the target mail server, the independent hash value of the content of the email message using the hashing algorithm;
requesting a validation hash value from a mail verification agent associated with a domain name system of the received email message;
comparing the independent hash value to the validation hash value; and
responsive to a result of the comparing being positive or negative, sending, by the target mail server, a responsive communication to the target recipient.

13. The computer system of claim 12, further causing the processor set to perform a method comprising:
identifying the mail verification agent for a sending domain name system of the email message;
wherein:
retrieving the hashing algorithm includes obtaining a resource record for the mail verification agent, the resource record indicating the hashing algorithm.

14. The computer system of claim 12, wherein requesting the validation hash is performed by submitting a query containing only the message identifier to the mail verification agent.

15. The computer system of claim 12, wherein the content of the email message includes only message content.
